(19) United States
(12) Patent Application Publication
(10) Pub. No.: US 2012/0136761 A1
(43) Pub. Date: May 31, 2012

(54) SYSTEM AND METHOD OF OPERATING A SHARIA COMPLIANT PAYMENT CARD

(75) Inventor: Adnan Al Bahar, Safat (KW)

(73) Assignee: The International Investor KSCH

(21) Appl. No.: 13/126,626

(22) PCT Filed: Jan. 9, 2009
(86) PCT No.: PCT/IB09/50090

§ 371 Date: Jun. 30, 2011

(30) Foreign Application Priority Data
Nov. 6, 2008 (GB) 0820304.4

(51) Int. Cl. G06Q 20/24; G06Q 40/02; G06Q 20/10; G06Q 20/20

(52) U.S. Cl. 705/30; 705/38

(57) ABSTRACT

A method for a transaction that is compliant with Sharia law and a payment card for implementing the method are disclosed.

### TECHNICAL FIELD

The present disclosure relates to the delivery of a Sharia compliant instalment finance contract via a smart card. In particular, in some implementations the smart card can co-exist on a Bank issued scheme card or credit card.

### BACKGROUND OF THE INVENTION

The principle of borrowing and lending without payment of fixed interest (or riba) forms one of the central tenets of Islamic economics and represents one of the key differences between Islamic and Western economic models. Murabahah is an Islamic “cost plus” mortgage transaction, wherein instead of lending money to a buyer to enable them to purchase an item, a bank buys the item themselves (from the seller) and re-sells the item to the buyer at a profit margin agreed to by both parties (wherein the buyer may pay the bank in instalments). In effect, this is a fixed-income loan for the purchase of the real-asset, wherein the bank is compensated for the time-value of its money in the form of the profit margin. However, the bank is not compensated for the time-value of the money outside of the contracted term (i.e. the bank cannot charge additional profit on late payments).

The purchase and selling price, other costs and the profit margin must be clearly stated at the time of the sale agreement. In order to protect itself against default, an Islamic bank typically asks for strict collateral. Furthermore, the asset remains as a mortgage with the bank until the Murabahah is paid in full.

### SUMMARY OF THE INVENTION

According to a first aspect of the invention there is provided a method of providing a Sharia compliant payment on a smart card the steps comprising of:
(a) receiving a value of a transaction;
(b) receiving a percentage profit for the transaction;
(c) using the value of the transaction to determine one or more differing duration payment plans for the transaction;
(d) using the percentage profit to determine a profit accrued over the duration of each payment plan;
(e) calculating one or more cumulative payable amounts from the sum of each overall profit(s) and the value of the transaction;
(f) calculating an instalment amount that a user of the payment card shall pay at pre-defined interval(s).
(g) allowing the user to select one of the payment plans
(determined in (c));
(h) accepting payment of the instalment amount for the selected payment plan at each of the pre-defined intervals occurring within the duration of the payment plan; and
(i) updating an account of the user to reflect the accepted payment.

All of the above is performed on a point of sale (POS) terminal.

Preferably, the step of allowing the user to select one of the payment plans is preceded by the steps of:
determining from a one or more financial variables stored on the payment card, a maximum amount the user of the payment card can afford to pay at pre-defined regular intervals;
displaying to the user those one or more payment plans whose instalment amounts are less than the maximum amount a user of the payment card can afford to pay at the pre-defined intervals occurring within the duration of the one or more payment plans.

Preferably, the step of determining the maximum amount the user of the payment card can afford to pay at pre-defined regular intervals comprises the steps of:
determining an overall amount the user of the payment card can afford to pay at the pre-defined intervals; and
subtracting therefrom the amount of any payments which must be made in respect of other transactions made earlier with the payment card.

Desirably, the step of updating an account of the user to reflect the accepted payment comprises the step of reducing the amount of any payments which must be made in respect of other transactions made earlier with the payment card, on receipt of a payment of a final instalment amount for a one or more of the previously made transactions.

Desirably, the step of accepting payment from the user of the instalment amount comprises the step of accepting payment made through the Internet or a direct debit.

Preferably, the method comprises the steps of:
the POS terminal communicating with a centralised host system in the event the instalment amount of all the payment plans exceeds the maximum amount the user of the payment card can afford to pay at regular intervals; and
issuing instructions from the host system to the POS terminal to allow a payment plan to be made available to the user in the event the user has a good repayment history.

Preferably, the method comprises the step of allowing a user to select a payment plan for a first transaction made without the payment card.

The above steps can be carried out offline.

According to a second aspect of the invention, there is provided a system for operating a Sharia compliant payment card, the system comprising means adapted for performing the method of the first aspect.

Preferably, the payment card is adapted to store financial variables in a silicon chip embedded in the card.

### BRIEF DESCRIPTION OF THE DRAWINGS

An embodiment of the invention is herein described by way of example only with reference to the accompanying Figures in which:

FIG. 1 is a block diagram of a system of operating a Sharia compliant credit card in accordance with the second aspect of the invention;

FIG. 2 is a flowchart of the method of operating a Sharia compliant credit card in accordance with the first aspect of the invention;

FIG. 3 is a table of repayment tenures stored in a memory of a POS terminal in the system shown in FIG. 1; and

FIG. 4 is a table of exemplary potential payment plans calculated using the method shown in FIG. 2.

A customer can apply for a transaction card by completing an application form available in store or on a website. Once an application has been approved, the customer is allocated an MRL (Monthly Repayment Limit), a fixed amount that the customer is able to pay as a monthly repayment from the customer. The MRL is allocated on an individual basis, based on an assessment of the customers monthly income and any other pre existing monthly repayment commitments. This information is then rated against risk based scorecard. Allocation of an MRL provides the customer with CRA (Cumulative Repayment Amount) which is stored on the CHIP of the smart card. By subtracting the CRA from the MRL the POS calculates the customers' available monthly instalment capacity (called the MAL, or Monthly Available Limit).

The Flair card stores the financial variables in a semiconductor chip embedded in the card. In one embodiment, the master record of the card holder's current Flair financial position is hosted on this chip, as opposed to other payment solutions where the master record resides in a back end system.

### DETAILED DESCRIPTION

The preferred embodiment comprises a system and method of operating a payment card using a Murabahah contract. In particular, the preferred embodiment provides a Sharia compliant payment card solution.

Synchrony between the embedded chips in the payment cards and the host system 10 is maintained by:
daily data uploads from the POS terminals 5 to the host system 10 for recent offline transactions; and
connections between the payment cards and the host system 10 (through the POS terminals 5) for account maintenance and receipt of new chip information from the host system 10.

The embedded chips in the payment cards use a known debit technology (e.g. Mastercard (trade mark) MChip/4 pre-authorised debit technology) to store the values of a Maximum Repayment Limit (MRL) and a Cumulative Repayment Amount (CRA) variable. The MRL variable governs the total amount a customer can repay in a given month, thereby indirectly limiting the total amount of debt a customer can incur at a given time. The making of purchases does not affect the value of the MRL variable. In contrast, every successful purchase increases the value of the customer's CRA variable by a value of a monthly instalment selected by the customer for that purchase. Indeed, a CRA value only decreases when the last instalment of a purchase contract has been honoured.

No further information needs to be stored on the embedded chips in the payment cards, thereby greatly simplifying the implementation of the preferred embodiment. It will be understood that the preferred embodiment is not limited to the Mastercard (trade mark) MChip/4 pre-authorised debit technology. In particular, the preferred embodiment is operable with any appropriate debit technology.

The payment cards of the preferred embodiment have three possible configurations, namely, instalment plan, loyalty, and instalment plan and loyalty. With an instalment plan configuration, a customer will not earn loyalty points for transactions made with the payment card. With a loyalty configuration, the customer will not be able to purchase goods on instalment, but will still be able to earn loyalty points on purchases made by other means (i.e. cash, credit card, etc.). With an instalment plan and loyalty configuration, the customer will earn loyalty points for transactions made on instalment with the payment card.

The choice of a particular configuration reflects the services a merchant M₁-Mₙ is willing to provide and the services a customer wishes to avail of with the payment card. In support of this process, the POS terminals 5 may be provided with a look-up table (LUT) indicating whether a merchant M₁-Mₙ supports loyalty transactions. Similarly, if the monthly repayment limit (MRL) of a payment card is set to zero, the card cannot support an instalment plan configuration; and only loyalty transactions can be made with the card.

### Method of the Preferred Embodiment

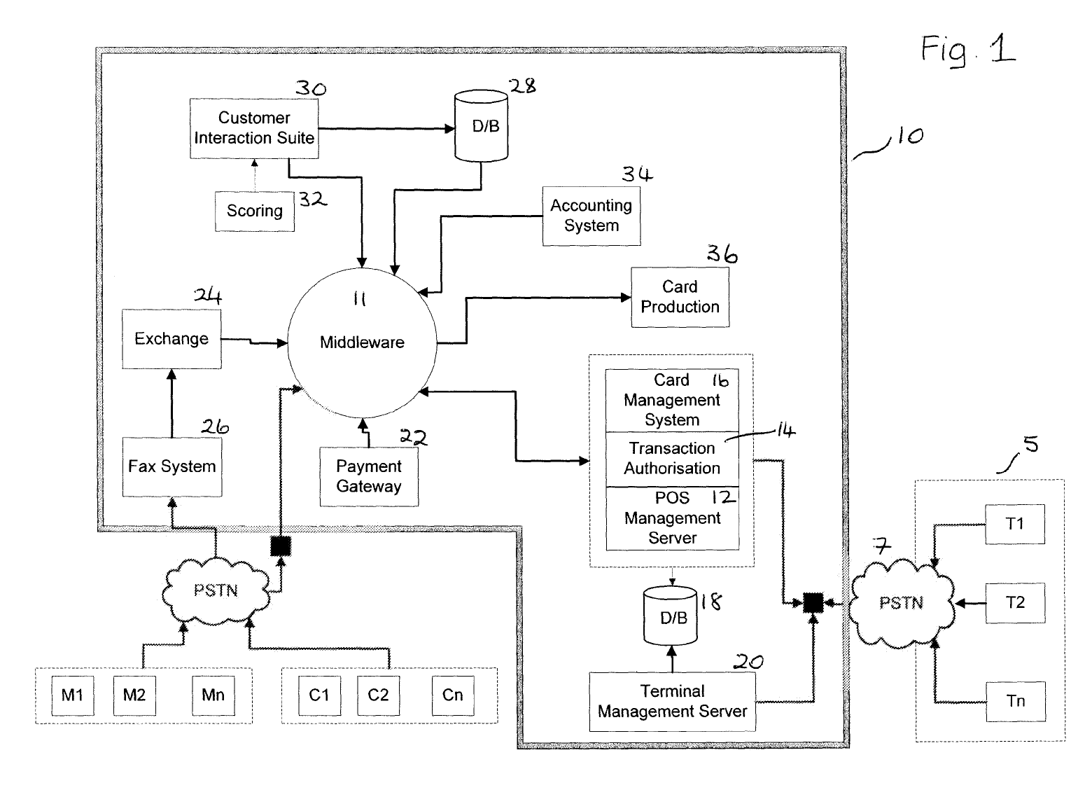

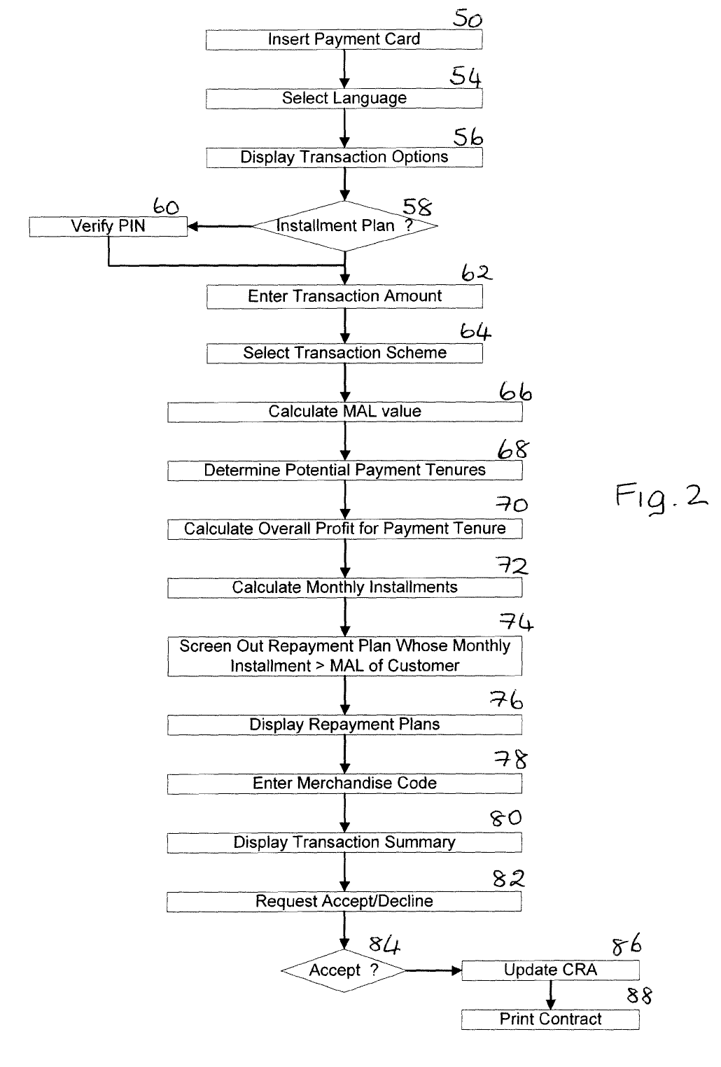

Referring to FIG. 2 in combination with FIG. 1, in use, the payment card is inserted 50 into a POS terminal (e.g. T₁) for card validation. The POS terminal T₁ displays 52 the language options (e.g. Arabic and English) available and allows the user to select 54 a language in which the final transaction slips are to be printed. The user is then prompted 56 with a list of transaction options, namely “instalment plan” and “loyalty only”.

As mentioned previously, the transaction options available to the user depends on the configuration of (e.g. the LUT in) the POS terminal T₁ and the user's payment card. The POS terminal T₁ also provides the user with an option for making a payment, performing account maintenance, or displaying the MAL balance.

### (a) Instalment Plan Transaction

In the event the user has selected 58 the “Instalment plan” option, the POS terminal T₁ prompts the salesperson to enter 62 the transaction amount (i.e. the sum of the total goods purchased value). The POS terminal T₁ then prompts the salesperson to select 64 an appropriate transaction scheme (e.g. a standard scheme with 5% profit, a 0% profit scheme, a winter sale promotion with a 3% profit etc.) for the purchase.

The POS terminal T₁ then calculates 66 the value of a monthly available limit (MAL) variable (by subtracting the CRA from the MRL (i.e. MAL=MRL−CRA)) for the customer. The MAL is the maximum amount a customer can afford to repay on a monthly basis at that point in time. Since the M/Chip4 debit technology employed in the present example defines the MRL and CRA variables, the present example stores these two variables in the embedded chips in the payment cards. Nonetheless, it will be appreciated that the preferred embodiment could alternatively store only the MAL variable on the embedded chips in the payment cards.

If an account is to be blocked due to delinquency, the payment card is put on a stoplist (by the Terminal management server 12) and the host system 10 sets the CRA equal to the MRL which will effectively set MAL=0.

The POS terminal T₁ compares the transaction value with a table of repayment tenure bands as shown in FIG. 3 to determine 68 potential repayment tenures of the Murabahah contract for the proposed purchase. Thereafter, the POS terminal T₁ calculates 70 the overall profit incurred over the duration of a potential repayment tenure, using the expression

$$profit = \frac{tenure ( rate \times amount )}{12} ,$$

wherein rate is the percentage profit of a selected transaction scheme, tenure is the number of months of a potential repayment tenure and amount is the value of the purchase.

The POS terminal T₁ then adds the calculated overall profit to the value of the transaction itself (i.e. the principle) and calculates 72 the value of the monthly instalments that the customer would have to pay to satisfy the Murabahah contract over the duration of the different potential repayment tenures. The POS terminal T₁ then screens out 74 those repayment plans whose monthly instalments exceed the MAL of the customer. The POS terminal T₁ then displays 76 a table comprising details of the overall profit and principle, repayment tenure and monthly instalment values of the resulting repayment plans. Assuming that the monthly repayment value does not exceed a customer's MAL, the table always lists a repayment plan with a minimum tenure of one month. The customer is then prompted to select one of the available repayment plans.

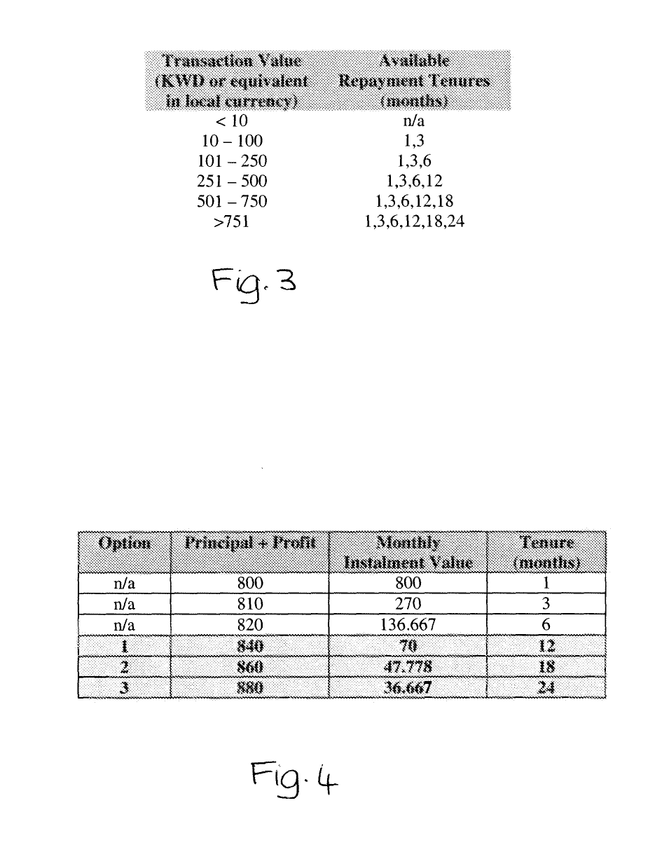

For example, say a customer wishes to purchase goods to the total value of KWD 800. Let the customer's payment card have a current MRL and CRA value of 500 KWD and 400 KWD respectively. Thus, MAL=100 KWD, so that the customer can still purchase goods for a transaction value and on an instalment plan with a repayment amount of KWD 100 per month. Let the profit resulting from the selected transaction scheme be 5%. Thus, the possible repayment plans for the customer are shown in FIG. 4. Since in this example, MAL=100, the available repayment plans for the customer are shown in bold font. Should the customer choose option 1, the customer's CRA will increase to 470 and the effective MAL decrease to 30.

On receipt of a selection of a desired repayment plan, the POS terminal T₁ prompts 78 the salesperson to enter a code designating the nature of the merchandise purchased (wherein a LUT of the appropriate codes is stored in the POS terminal T₁). The POS terminal T₁ then displays 80 a summary of the entire transaction (including the merchandise type, the transaction value, the instalment value, the repayment tenure and the total Murabahah value [i.e. principal+profit]) and requests 82 the customer to enter their PIN to accept the transaction. In the event the user has entered an incorrect PIN, the POS terminal T₁ prompts the user to re-enter the PIN. In an effort to reduce the risk of fraud and security breaches, the user is provided with a limited number of opportunities to enter their PIN. The number of these opportunities is configurable by the operator of the POS terminal T₁. In the event the customer does not enter the correct PIN within the designated number of attempts, further interactions with the customer are frozen and a PIN retry counter stored in the embedded chip in the payment card must be reset from the host system 10 before the payment card can be used again. The PIN can alternatively be verified immediately the instalment plan is selected, as shown in FIG. 3.

If the customer accepts 84 the transaction, the CRA of the card is updated 86 on the embedded chip and the POS terminal T₁ prints 88 a Murabahah contract for the customer to sign. If a loyalty only transaction type was selected, the instalment value, repayment tenure and Murabahah value will not be displayed.

### (b) Payment Transaction

In the event the customer selects the option for “making a payment” (from the list of displayed transaction options (56)) the POS terminal T₁ allows the customer to enter a desired payment amount. The POS terminal T₁ then connects with the host system, and sends a transaction to the host system for subsequent batch processing. The POS terminal T₁ also prints a transaction slip, stating the date/time, card number, payment amount and currency.

### (c) Account Maintenance

A user can select the option for “account maintenance” (from the list of displayed transaction options (56)) for online account maintenance from the POS terminal T₁. The user could select this option for an update to the MRL or CRA value in the embedded chip of the customer's payment card during supplementary card applications and for any other chip updates including unblocking of a card if appropriate. Account maintenance can also be used to update the embedded chip when a final instalment loan payment is received by the host system but not yet reflected in the embedded chip; and the customer wants to use the updated MAL for new purchases.

If necessary, the POS terminal T₁ may also connect to the host system (in the event a customer select the option for “account maintenance), to make any necessary financial updates to the host system. Furthermore, should the POS terminal T₁ connect to the host system for any reason during an instalment transaction, the transaction will become an account maintenance transaction; and the POS terminal T₁ will send an account maintenance message to the host system. A warning message is displayed (by the POS terminal T₁) to the customer, who can re-initiate the instalment transaction (after a successful embedded chip/host system update) by re-inserting the payment card in the POS terminal T₁.

(d) Online Transactions with the Host System

Despite the emphasis on off-line transaction authorisation, nonetheless, there are instances wherein an on-line communication between a POS terminal T₁ and the host system 10 of the preferred embodiment is required. In particular, the first time a payment card is used, the transaction is performed online so that the MRL and CRA on the payment card can be set to the appropriate amount.

Similarly, in the event a payment card has insufficient MAL (so that no repayment plan options are available for the customer), the POS terminal T₁ will check with host system 10 as to whether a final instalment payment has perhaps been made (which will increase the MRL and therefore increase the MAL by the instalment payment amount). It may also be necessary to connect a POS terminal T₁ with the host system 10, to update data in a payment card's embedded chip (or in the event the card is blocked for some reason). The payment cards to be updated are identified in a stoplist (which is periodically (for example, daily) downloaded from the host system) in the POS terminal T₁. On detecting a payment card from its stop-list, a POS terminal T₁ automatically connects to the host system 10. In the event the card is blocked, the host system 10 will return a decline code (e.g. “do not honour”, “pick-up card”, etc.). An update is also required on receipt of a final instalment towards a purchase contract (i.e. so that the MRL must be increased with the instalment amount) or in the event the host system 10 wants to update other parameters on the card (e.g. increasing the MRL for customers with a good repayment history).

Alterations and modifications may be made to the above without departing from the scope of the invention.

1. A method of providing a Sharia compliant payment on a smart card, the method comprising the steps of:
(a) receiving a value of a transaction;
(b) receiving a percentage profit for the transaction;
(c) using the value of the transaction to determine one or more differing duration payment plans for the transaction;
(d) using the percentage profit to determine a profit accrued over the duration of each payment plan;
(e) calculating, for each payment plan, an overall payable amount from the sum of the overall profit for that payment plan and the value of the transaction;
(f) calculating, for each payment plan, an instalment amount that a user of the payment card shall pay at pre-defined interval(s) over the duration of the payment plan, said instalment amount being derived from the ratio of the overall payable amount to the number of the pre-defined intervals that occur in said duration;
(g) allowing the user to select one of the payment plans (determined in (c));
(h) accepting payment of the instalment amount for the selected payment plan at each of the predefined intervals occurring within the duration of the payment plan; and
(i) updating an account of the user to reflect the accepted payment.

2. The method of claim 1, wherein the method is performed on a point of sale (POS) terminal.

3. The method of claim 1, wherein the step of allowing the user to select one of the payment plans is preceded by the steps of:
determining from a one or more financial variables stored on the payment card, a maximum amount the user of the payment card can afford to pay at pre-defined regular intervals; and
displaying to the user those one or more payment plans whose instalment amounts are less than the maximum amount a user of the payment card can afford to pay at the pre-defined intervals occurring within the duration of the one or more payment plans.

4. The method of claim 3, wherein the step of determining the maximum amount the user of the payment card can afford to pay at pre-defined regular intervals comprises the steps of:
determining an overall amount the user of the payment card can afford to pay at the pre-defined intervals; and
subtracting therefrom the amount of any payments which must be made in respect of other transactions made earlier with the payment card.

5. The method of claim 1 wherein the step of updating an account of the user to reflect the accepted payment comprises the step of reducing the amount of any payments which must be made in respect of other transactions made earlier with the payment card, on receipt of a payment of a final instalment amount for a one or more of the previously made transactions.

6. The method of claim 1 wherein the step of accepting payment from the user of the instalment amount comprises the step of accepting payment made through the Internet or a direct debit.

7. The method of claim 2, further comprising the steps of:
the POS terminal communicating with a centralised host system in the event the instalment amount of all the payment plans exceeds the maximum amount the user of the payment card can afford to pay at regular intervals; and
issuing instructions from the host system to the POS terminal to allow a payment plan to be made available to the user in the event the user has a good repayment history.

8. The method of claim 1 further comprising the step of allowing a user to select a payment plan for a first transaction made without the payment card.

9. The method of claim 1, wherein the method is carried out offline.

10. A system for operating a Sharia compliant payment card, the system comprising means for performing the method of claim 1.

11. The system of claim 10, wherein the payment card stores financial variables in a silicon chip embedded in the card.
